(19) United States
(12) Patent Application Publication
(10) Pub. No.: US 2022/0398484 A1
(43) Pub. Date: Dec. 15, 2022

(54) METHOD AND SYSTEM FOR CONTROLLING A QUBIT FOR OBTAINING A SCALABLE STRUCTURE OF A HYBRID QUANTUM-CLASSICAL ARCHITECTURE

(71) Applicant: QPIAI INDIA PRIVATE LIMITED, Bangalore (IN)

(72) Inventors: PINAKIN MANSUKHLAL PADALIA, Rajkot (IN); Nihal Sanjay Singh, Bangalore (IN); Umang Garg, New Delhi (IN); Amlan Mukherjee, Durgapur (IN); Nagendra Nagaraja, Bangalore (IN)

(21) Appl. No.: 17/839,410

(22) Filed: Jun. 13, 2022

(30) Foreign Application Priority Data
Jun. 12, 2021 (IN) 202141026277

(51) Int. Cl. G06N 10/80; G06N 10/20

(52) U.S. Cl. CPC G06N 10/80; G06N 10/20

(57) ABSTRACT

A system and a method for controlling a qubit in a decentralized and distributed manner to obtain a scalable structure of a hybrid quantum-classical architecture is disclosed. The system includes a circuit configured to provide an operation frequency control of qubits in an island representation of a logical qubit island with a plurality of physical qubits along with independent magnetic-field control to each qubit on a hardware substrate. The circuit includes a plurality of micro/nano-scale current-carrying structures in the vicinity of a qubit for controlling and manipulating the qubit using the locally generated variable magnetic field, in turn controlled by a tunable current flowing through the plurality of micro/nano-scale current-carrying structures. The plurality of micro/nano-scale current-carrying structures in conjunction with a fast current control are configured to provide fast switching/tuning of magnetic fields enabling rapid adiabatic passage control of one or more qubits simultaneously.

### BACKGROUND

### Technical Field

The present invention is generally related to the field of quantum computing and quantum hardware design. The present invention is particularly related to a system and method for providing a scalable architecture for the co-integration of quantum and classical microprocessors/controllers. The present invention is more particularly related to method and system for controlling a qubit for obtaining a scalable structure of a hybrid quantum-classical architecture.

### Description of the Related Art

Generally, quantum computers have the potential for exponential speed up when compared to classical computers for certain classes of computations. Quantum computers inherently possess multiple unique properties that set them apart from classical computers. The two prominent properties of Quantum Computers are superposition and entanglement. Due to exponential calculation speed, the Quantum Computers are opted in a wide range of applications including fields such as optimization, database search, logistics, drug discovery, and cryptography.

Quantum Computers consist of quantum bits (alternatively termed as qubits) as the processing units. The qubits are capable of executing certain algorithms with an exponential efficiency, allowing algorithms to be executed in finite polynomial-time duration as compared to the classical processing units, which would take unviable times to complete the task. In one instance, a qubit is described as a two-level system with the ability to be in a quantum superposition state of the two levels. Due to the two-level state of the qubit, multiple hardware implementations that are based on the idea of finite-level systems are feasible in Quantum Computers. The multiple hardware implementations include, but not limited to, spin qubits in semiconductors, superconducting qubits, spin qubits in NV centers in diamonds, etc.

One implementation of a spin qubit in the Quantum Computers is based on isolation of a single electron in 3-dimensional quantum confinement and availability of an external magnetic field B₀, to separate the degenerate spin states of the electron into a two-level system. These states form the ground state and the excited state of the spin qubit. The ground and the excited state of the spin qubit are represented by the following key notation: |0> and |1>. The state of a qubit is then represented by a wave function |ψ>=α|0>+β|1>, where α and β are complex numbers representing the probability amplitudes of qubit |ψ> being in the state |0> and state |1> respectively. From Born's interpretation, the actual probability of |ψ> being in state |0> is given by |α|\hat{ }2 and that being in state |1> is given by |β|\hat{ }2. An enter array of n such qubits can be superimposed with each other to generate a linear combination of 2\hat{ }n possible states where the computation can be done parallelly on all the 2\hat{ }n states in one go.

Further, in various applications, large numbers of qubits may be required to perform large quantum simulations. Quantum computing architectures that support large quantum simulations are called multi-qubit architectures. To achieve large quantum simulations in multi-qubit architecture, multiple spin qubits can be associated together and enabled to interact with each other to result in an extended quantum state. The quantum computer supports superposition and coupling of a larger number of qubits with each other. In an example, number of qubits can be superimposed and a combined state of such superimposed system can be written as a linear superposition equation, which is represented by: |ψ>=Σₖ²^{ⁿ} αₖ|k>, where |k> represents a state of at least one qubit and αₖ represents the complex amplitude corresponding to the state |k>. To practically implement the large quantum simulations, several challenges need to be addressed for assembling a viable computer and scaling it up to millions of qubits. The challenges could include addressability for control and readout for each qubit in the system, decoherence of qubits, the fidelity of operation and readout, connectivity between qubits and coupling control, and scalability to millions of qubits.

Currently, some of the multi-qubit architectures utilize multiplexing schemes. The remaining multi-qubit architectures that are implemented without provision for multiplexing are not scalable inherently as they entail increasing hardware complexity in proportion to the number of qubits. The scalable multi-qubit architectures that exploit frequency multiplexing schemes require qubits with different resonant frequencies. The existing models of these multi-qubit architectures utilize micro-magnet patterns to generate the longitudinal magnetic field gradient needed for the well-separated qubit resonance frequencies (alternatively known as Larmor frequencies). The mentioned method is challenging and inconvenient to be executed in standard fabrication processes as the method does not allow any tunability in the magnetic field post-fabrication and contains a constant ever-present magnetic field. And hence, the existing architectures lack the ability to encapsulate all the functionalities needed in a hierarchical hybrid quantum computer.

Also, the majority of the existing architectures do not account for a large number of physical qubits (PQBs) required for the construction of a logical qubit (LQB) post error correction. The remaining architectures that account for the large number of physical qubits do not consider the added challenge of regulating the resonance frequencies for all the PQBs comprising an LQB. Further, few of other existing architectures limit two-qubit operations only to spatially adjacent qubits, which in turn hinders the overall computation that can be carried out on the quantum processor.

Further, each qubit in an existing multi-qubit environment is unique and needs to be addressed individually for control and readout. Moreover, multiple control and readout lines are required to fully control and operate on an individual qubit. The qubits in the existing architectures operate at sub-Kelvin temperatures, and control electronics operating at room temperature, and hence, a huge number of interconnect cables are needed to connect the room temperature setup to the qubit chip. Although such a solution is suitable for a few qubits, it becomes infeasible for scaling up to thousands of qubits due to the shear heat load, and the number of interconnected lines that need to run from room temperature to the cryogenic setup.

Furthermore, the existing multi-qubit spin architectures suffer from limited coherence times of the qubits. The state of a qubit needs to be preserved for at least the duration of the algorithm. This would require the use of quantum error correction techniques and encoding a single logical qubit in multiple physical qubits. However, performing quantum error correction requires operations to be performed on physical qubits apart from the simulations to be carried out corresponding to an algorithm on the qubit. To address the current problem, the existing systems enable the multi-qubit architecture to execute interleaving of the algorithmic operations with quantum error corrections to maintain the state of the qubit. However, enabling the multi-qubit architecture to execute interleaving of the algorithmic operations burdens a single microprocessor or a controller with scheduling a multitude of operations at the same time, making it an overwhelming task when there are multiple qubits to be addressed and operated on along with simultaneously preserving their state via error correction.

Hence there is need for a method and a system for effectively controlling qubit resonance frequencies in a multi-qubit architecture, while also paving the way for the distribution of computational tasks of an algorithm across various layers of abstraction in the multi-qubit architecture. Further there is a need for a system and method for co-integrating the physical qubit structures to a logical qubit island with a controlled Larmor frequency. Yet there is a need for a system and method for co-integrating multiple logical qubit islands with microprocessors/controllers in a hierarchical fashion allowing for distributed computing and ease of scaling. Yet there is a need for a system and method for distributing quantum error correction and other operational tasks at various levels of hierarchy thereby allowing for ease of scale. Yet there is a need for a system and method for modularizing and repeating classical hardware required for quantum computing. Yet there is a need for a system and method for an electro-optical control of photonic links using microprocessors/controllers to set qubit interaction levels between islands of qubits. Yet there is a need for a system and method for a hierarchical quantum and classical hardware integration thereby providing a generalized architecture for a hybrid quantum computer. Yet there is a need for a system and method for providing an architecture that allows reusability of the same set of Larmor frequencies over multiple logical qubit islands, thereby significantly reducing the control and readout hardware overheads.

The above-mentioned shortcomings, disadvantages and problems are addressed herein, and which will be understood by reading and studying the following specification.

### SUMMARY

This summary is provided to introduce a selection of concepts in a simplified form that are further disclosed in the detailed description. This summary is not intended to determine the scope of the claimed subject matter.

The embodiments herein address the above-recited needs for a system and a method for a system and method for providing an architecture that allows reusability of the same set of Larmor frequencies over multiple Logical qubit islands, thereby significantly reducing the control and readout hardware overheads.

According an aspect, a system for controlling a qubit to obtain a scalable structure of a hybrid quantum-classical architecture is provided. The qubits are controlled in a in a decentralized and distributed manner The system includes a circuit configured to provide an operation frequency control of qubits in an island representation of a logical qubit island with a plurality of physical qubits along with independent magnetic-field control to each qubit on a hardware substrate. The circuit includes a plurality of micro/nano-scale current-carrying structures in the vicinity of a qubit for controlling and manipulating the qubit using the locally generated variable magnetic field, in turn controlled by a tunable current flowing through the plurality of micro/nano-scale current-carrying structures.

The plurality of micro/nano-scale current-carrying structures in conjunction with a fast current control are configured to provide fast switching/tuning of magnetic fields enabling rapid adiabatic passage control of one or more qubits simultaneously. The multiple physical qubits are combined to form a logical qubit.

The logical qubit comprises an island of qubits and wherein the logical qubit is provided with an operating resonance frequency or Larmor frequency, controlled by the plurality of micro/nano-scale current-carrying structures. The multiple logical qubits or islands of qubits are interconnected via optical links leveraging spin-photon entanglement, wherein the optical links are referred to as photonic links. The photonic links are capable of connecting multiple logical qubits with high data rates. The photonic links are made of high-K material or photonic crystals, wherein the photonic links are controlled by electro-optical modulators.

In an embodiment, the system further includes one or more microprocessors placed in a hierarchical fashion, and responsible for one or more of: controlling qubit couplings, quantum error correction, algorithm execution, compilation, and synchronization, depending on a level of hierarchy.

In an embodiment, the lowest level microprocessors or controllers are responsible for one or more of controlling the coupling between any two adjacent logical qubits, defining the resonance frequencies of the logical qubits by modulating the current in the corresponding current-carrying structures, reading and controlling the logical qubits, and running quantum error-correction cycles on the adjacent logical qubits.

In an embodiment, the system further includes one or more microprocessors at higher levels in the hierarchy and responsible for one or more of controlling the coupling between two-level structures, passing the required control sequences for qubit operation to the microprocessor or controller at the lower hierarchy level, and maintaining the timing accuracy of the operations. The microprocessors or controllers at an even higher level of the hierarchy are responsible for the mapping of software qubits to hardware qubits in the most optimized manner.

In an embodiment, at the highest level of hierarchy, a master microprocessor is responsible for synchronization and compilation of various algorithms that are required to be executed on quantum bits.

In an embodiment, a memory structure is shared between the master microprocessor and the quantum computing block.

In an embodiment, the architecture is both modular and scalable, wherein hierarchical repetition of multiple microprocessors or controllers tasks allows for optimal hardware design and dynamic control.

In an embodiment, the design of the architecture can be extended to a plurality of qubits by adding more qubit islands into the architecture design.

In another aspect, a method for controlling a qubit in a decentralized and distributed manner to obtain a scalable structure of a hybrid quantum-classical architecture is provided. The method includes integrating a physical qubit structure into a logical qubit island while establishing a controlled Larmor frequency. The method further includes integrating a plurality of logical qubit islands with one or more microprocessors/controllers in a hierarchical fashion, for enabling a distributed computing and ease of scaling. The method furthermore includes integrating a hierarchical quantum hardware and a classical hardware to form a generalized architecture for a hybrid quantum computer.

In an embodiment, integrating a physical qubit structure into a logical qubit island includes cleaning a typical silicon substrate, forming a typical gate oxide and depositing a gate layer, performing doping for source and drain region and forming contact to source, drain and gate in subsequent metallization process, etching is performed to remove excess metal, and depositing an oxide layer and then metallization and patterning to achieve the required metal loop structures for realizing current carrying loop in subsequent metal layers.

In an embodiment, the method further includes forming a required contact to the qubits and the metal loops in subsequent metal layers, wherein a number of qubits in an island is selectable by a user depending on a number of physical qubits needed for a single logical qubit.

In various embodiments, the microprocessors or the controllers are placed in a hierarchical fashion, and are responsible for one or more of controlling qubit couplings, quantum error correction, algorithm execution, compilation, and synchronization, depending on the level of hierarchy. Further, the lowest level microprocessors or controllers are responsible for one or more of controlling the coupling between any two adjacent logical qubits, defining the resonance frequencies of the logical qubits by modulating the current in the corresponding current-carrying structures, reading and controlling the logical qubits, and running quantum error-correction cycles on the adjacent logical qubits. Furthermore, the microprocessor or controllers at higher levels in the hierarchy are responsible for one or more of controlling the coupling between two-level structures, passing the required control sequences for qubit operation to the microprocessor or controller at the lower hierarchy level, and maintaining the timing accuracy of the operations. The microprocessors or controllers at an even higher level of the hierarchy are responsible for the mapping of software qubits to hardware qubits in the most optimized manner.

One of the major concerns for quantum processors is the ability to scale to larger and larger number of qubits. The present technology solves the above technical problem with the design of a modular architecture that makes use of unit cells of logical qubits that can be controlled as a single unit and integrated together in various topologies and scaled up by simple replication of the single unit. Moreover, the architecture designed for single logical qubit in the present technology, with the current carrying loop structure, allows for tuning the operating frequency of the qubit. This gives the flexibility of operating two logical qubits (sitting side by side) at different operating frequencies, thereby avoiding crosstalk and noise. Moreover, the unit cell design makes it modular and easier to add more cells forming repetitive structures, thereby allowing for an easy scaling up of the solution. The role of the classical microprocessor/controller remains fixed depending on which hierarchy level it is placed on. However, it can also be programmed according to the user requirements, offering a standard hardware with flexibility to program as per the requirements.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

These and other objects and advantages will become more apparent when reference is made to the following description and accompanying drawings.

### BRIEF DESCRIPTION OF THE DRAWINGS

The other objects, features and advantages will occur to those skilled in the art from the following description of the preferred embodiment and the accompanying drawings in which:

FIG. 1 illustrates a system for controlling operation frequencies of the qubits in an island representation of a logical qubit island with multiple physical qubits, in accordance with an embodiment of the present invention;

FIG. 2 illustrates an exemplary system for generating and regulating local magnetic field variations for spin qubit manipulation using scalable quantum processors and micro-structures in integrated circuits, in accordance with an embodiment of the present invention;

FIG. 3 illustrates an exemplary system that illustrates a scaled up architecture of FIG. 2 with 2 hierarchy levels, in accordance with an embodiment of the present invention;

FIG. 4 illustrates an exemplary system that illustrates a scaled up architecture of FIG. 2 with multiple hierarchy levels, in accordance with an embodiment of the present invention;

FIG. 5 illustrates a block diagram of a hybrid quantum-classical architecture, in accordance with an embodiment of the present invention; and

FIG. 6 illustrates a flow chart explaining a method for controlling a qubit in a decentralized and distributed manner to obtain a scalable structure of a hybrid quantum-classical architecture, in accordance with an embodiment of the present invention.

Although the specific features of the embodiments herein are shown in some drawings and not in others. This is done for convenience only as each feature may be combined with any or all of the other features in accordance with the embodiments herein.

### DETAILED DESCRIPTION OF THE DRAWINGS

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The detailed description of various exemplary embodiments of the disclosure is described herein with reference to the accompanying drawings. It should be noted that the embodiments are described herein in such details as to clearly communicate the disclosure. However, the details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood however, it is not intended to limit the disclosure to the forms disclosed, but on the contrary, the disclosure is to cover all modifications, equivalents, and alternatives falling within the scope of the disclosure.

The various embodiments of the present invention provide a method and a system for controlling a qubit in a decentralized and distributed manner to obtain a scalable structure of a hybrid quantum-classical architecture.

According to one embodiment of the present invention, a system for controlling a qubit in a decentralized and distributed manner to obtain a scalable structure of a hybrid quantum-classical architecture is provided. The system comprises a circuit configured to provide an operation frequency control of the qubits in an island representation of a logical qubit island with multiple physical qubits along with independent magnetic-field control to each qubit on a hardware substrate. The circuit comprises a plurality of micro/nano-scale current-carrying structures in the vicinity of a qubit for controlling and manipulating the qubit using the locally generated variable magnetic field, in turn controlled by the tunable current flowing through these structures. The current-carrying structures in conjunction with fast current control are configured to provide fast switching/timing of magnetic fields enabling rapid adiabatic passage control of one or more qubits simultaneously. The tunability of the qubits allows post-fabrication setting of adaptive magnetic field strengths and frequency separation of qubits, thereby enabling the qubits to simultaneously realize their intended control signals without any added disturbance from neighboring qubits.

For post fabrication of the devices, it is required to characterize each qubit for its performance under different potentials and surrounding magnetic fields. For the same, the classical microprocessor/controller needs to be programmed to give adequate signals to the individual qubits as well as the current carrying loop microstructure. Once the program is generated and transferred to the device, the entire chip needs to be cooled down to temperatures below 4 Kelvin to test and verify the functionalities. However, cooling down to such low temperature is only required for certain kinds of qubits. If the qubit design themselves allows them to be operated at higher temperatures, then it is possible to perform the characterization at those temperatures itself. Post characterization of the qubits it is also required to characterize the coupling links between the qubit islands to determine the strength of coupling and the voltage ranges required for the same. These individual hardware characterizations will help in evaluating the performance of the chip.

Following the individual test and characterization, it is also required to perform the subsystem as well as system level checks and verification. This may include performing single qubit operations on the logical qubit island, performing 2 qubit operations on nearby qubits to ensure coupling and smooth operation, performing entanglement between 2 qubits, performing error correction cycles on qubits, performing a simple few gates algorithm to verify the functionality of the system, performing two separate operations on nearby qubits to characterize for crosstalk and interference, and the like. These tests can be performed on the hardware by writing standard test cases and executing them on the hardware.

The system of the present technology provides an architecture, wherein multiple physical qubits are combined to form a logical qubit. The logical qubit, which comprises an island of qubits, is provided with an operating resonance frequency (alternatively referred as Larmor frequency), which is controlled by the current-carrying structures. Multiple logical qubits or islands of qubits are interconnected via optical links leveraging spin-photon entanglement, wherein the optical links are referred to as photonic links. These photonic links are capable of connecting multiple logical qubits with high data rates. The photonic links, in one example, are made of high-K material or photonic crystals, wherein the photonic links are controlled by electro-optical modulators.

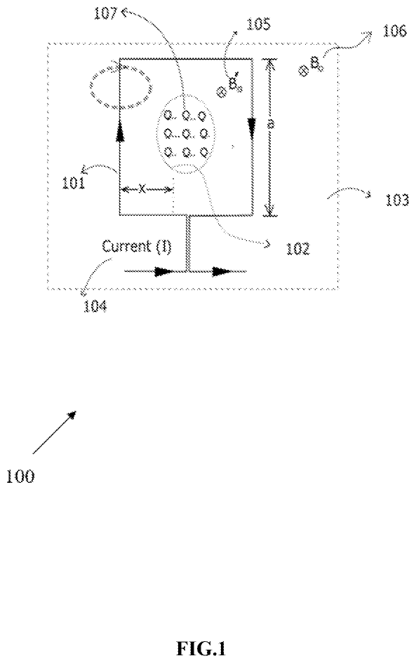

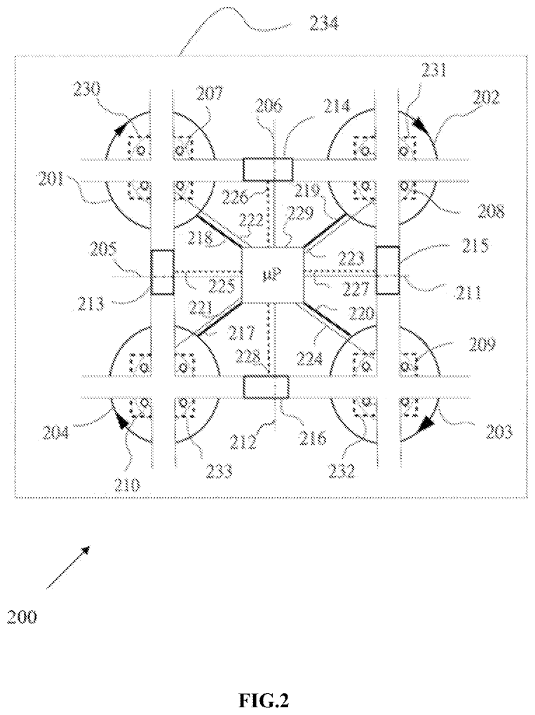

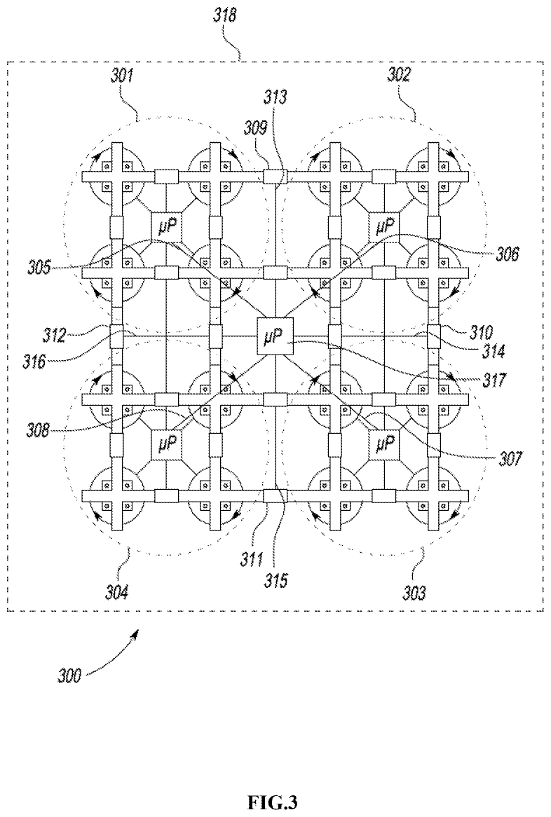

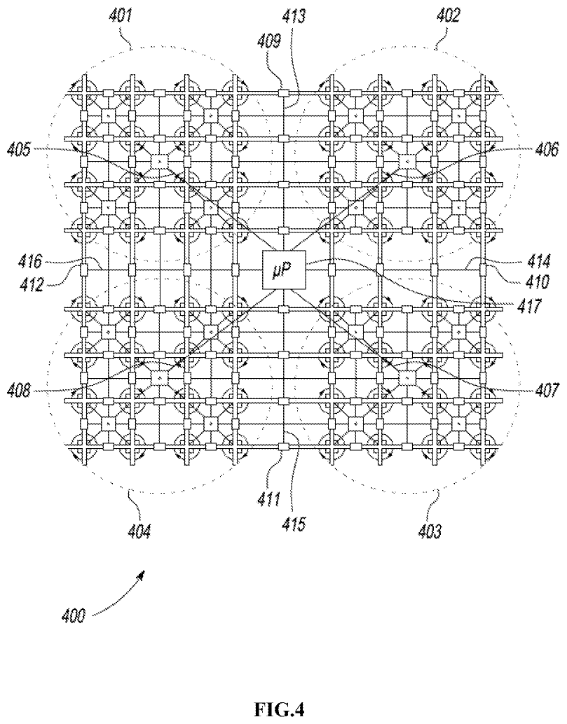

In various embodiments, the microprocessors or the controllers are placed in a hierarchical fashion, and are responsible for one or more of controlling qubit couplings, quantum error correction, algorithm execution, compilation, and synchronization, depending on the level of hierarchy. A lowest hierarchy level is the smallest unit in the hierarchy of the architecture is formed of the qubit island which acts as a single logical qubit as shown in FIG. 1. It consists of several physical qubits and a current carrying loop to create a local magnetic field over the physical qubit island (for example, an entire structure in FIG. 1 forms the lowest level in the hierarchy). The next level in the hierarchy is formed by the structure shown in FIG. 2, consisting of four units of logical qubits (each with several physical qubits and a current carrying loop) as shown in FIG. 1. These four units have different operating frequencies and are controlled by a classical microprocessor/controller. The entire system forms the second hierarchy. The next level in the hierarchy is formed by the structure shown in FIG. 3. It consists of 4 units of structures shown in FIG. 2. Hence, it is one hierarchy above the architecture shown in FIG. 2. Finally, FIG. 4 shows yet another level of hierarchy which is built upon FIG. 3. Hence, in total 4 hierarchy levels can be seen in the example of the invention. However, the levels are not limited by the number of hierarchy levels possible. The system can be expanded and scaled to achieve any number of levels as required by the application with FIG. 1 forming the base of all hierarchy levels. Moreover, modifications are permissible for optimizing the number of classical microprocessor/controllers that are required at each hierarchy level. For example, in FIG. 2 it is shown that a single microprocessor/controller controls and coordinates 4-unit cells of FIG. 1. However, it can also be used to control 8 such unit cells of FIG. 1. These modifications do not undermine the innovative idea of using unit cells as outlined in FIG. 1 for scaling and designing an architecture that is modular and can be expanded easily by replication of the unit cells formed at the lower hierarchy levels.

Further, the lowest level microprocessors or controllers are responsible for one or more of controlling the coupling between any two adjacent logical qubits, defining the resonance frequencies of the logical qubits by modulating the current in the corresponding current-carrying structures, reading and controlling the logical qubits, and running quantum error-correction cycles on the adjacent logical qubits. Furthermore, the microprocessor or controllers at higher levels in the hierarchy are responsible for one or more of controlling the coupling between two level structures, passing the required control sequences for qubit operation to the microprocessor or controller at the lower hierarchy level, and maintaining the timing accuracy of the operations. The microprocessors or controllers at an even higher level of the hierarchy are responsible for the mapping of software qubits to hardware qubits in the most optimized manner

Further, at the highest level of hierarchy, a master microprocessor is responsible for synchronization and compilation of various algorithms that are required to be executed on quantum bits. A memory structure is shared between the master microprocessor and the quantum computing block. The architecture is both modular and scalable, wherein hierarchical repetition of multiple microprocessors or controllers tasks allows for optimal hardware design and dynamic control. Further, such a design of the architecture can be extended to a large number of qubits by adding more qubit islands into the architecture design.

FIG. 1 depicts a system 100 for controlling operation frequencies of the qubits in an island representation of a logical qubit island with multiple physical qubits, in accordance with an embodiment. The system 100, in one example includes semiconductor-based spin qubits. In one embodiment, an electron may be isolated in a Complementary Metal Oxide Semiconductor (CMOS) technology under a certain temperature and biasing conditions of a transistor. Further, on applying of an external static magnetic field (B₀), the spin degeneracy of the isolated electron splits to form a two-level system required for qubit formation. The energy difference between the two levels directly relates to the operating frequency of the qubit.

The island representation of the qubit can be designed using any fabrication process. It can include not limited to standard CMOS or Fully Depleted Silicon on Insulator (FDSOI) or even field-effect transistor (Finfet) based fabrication process which are commercially available. Moreover, one can also custom fabricate it in any foundry and/or fabrication unit that allows for the formation of qubit structures and metal/superconducting loop structures for generating local magnetic fields. The basic requirement for the island structure is the capability to deposit various layers and formation of quantum bit structures which are capable of holding a finite number of electrons and availability of metal/superconductor-based current carrying loop structures that can be used for manipulating the local magnetic fields. For a general fabrication process, one would first go about making qubit islands, which can be in form of metal oxide semiconductor field effect transistors (MOSFETS). This is achieved by first cleaning a typical silicon substrate. Subsequently, a typical gate oxide is formed and gate layer is deposited. Following the gate deposition, doping is performed for source and drain region. The contact to source, drain and gate are made in subsequent metallization process. Later, etching is performed to remove excess metal and the process of forming a basic MOSFET, which can be utilized as a physical qubit, is accomplished. The current carrying loop can further be realized in subsequent metal layers by first depositing an oxide layer and then metallization and patterning to achieve the required metal loop structures. The required contact to the qubits and the metal loops can be done in subsequent metal layers. This completes a generalized fabrication of the basic requirements for the logical qubit island. Moreover, the number of qubits in an island is flexible and the user can decide how many physical qubits he/she would need for a single logical qubit.

The system 100 includes a metal-wire structure 101 that are introduced around a plurality of physical qubit structures 107. The plurality of physical qubit 107 may be represented as a logical qubit 102 positioned on a silicon substrate 103. As known in the art, any wire carrying current induces a proportionate amount of magnetic field in its periphery (Oersted's Law), the metal-wire structure 101 (loop in this case) carrying a current (Io) 104 will have an associated magnetic field (Bo′) 105 at the site of an electron serving as the spin qubit within the metal-wire structure 101. That is, with the flow of controlled current 104 flowing in the loop in addition to a constant externally applied magnetic field, a local magnetic field (Bo′) 105 may be generated to allow an establishment of a well-defined Larmor frequency. In a specific embodiment, based on the established Larmor frequency, the entire structure forms a single logical qubit island with no unwanted interference to any concerned entity. That is, the plurality of physical qubits 107 may be perceived as the logical qubit 102. The Larmor frequency, which is common across the logical qubit 102 is set by modulating a static magnetic field 106 in combination with the generated magnetic field with a current flowing in the metal wire structure 101.

In one embodiment, the metal-wire structure 101 may be circular in nature. In an alternate embodiment, the metal-wire structure 101 may be used to generate separate time-varying magnetic fields based on the requirement.

In another embodiment, the current 104 in the loop can traverse in the opposite direction to decrease the effective local magnetic field at the logical qubit 102. The static magnetic field (B_0) 106 induces an equal magnetic field for each qubit in the circuit. The system 100 of the present technology may be implemented with a microprocessor/controller, wherein the qubit islands gain a lowest level in an hierarchical architecture. In one embodiment, the implementation of four qubit islands along with the microprocessor/controller is described in FIG. 2.

FIG. 2 depicts an exemplary system 200 for generating local magnetic field variations required for spin qubit manipulation using scalable quantum processors and micro-structures in integrated circuits, in accordance with another embodiment. The system 200, includes multiple qubit islands 207, 208, 209, and 210 with the loops 201, 202, 203, 204 of current-carrying wires being placed side by side with varying currents to implement different magnetic fields for the multiple qubit islands and ensure a well-defined Larmor frequency for the respective qubit islands 207, 208, 209, and 210. In one example, the qubit structures may be a single physical qubit or a logical qubit consisting of multiple physical qubits. In one embodiment, the error correction cycles in each qubit island 207, 208, 209, or 210 and the current in the respective loops 201, 202, 203, or 204 are controlled by a microprocessor 229 via classical links shown as 221, 222, 223, 224 and 217, 218, 219, 220 respectively.

In another embodiment, a plurality of optical links 213, 214, 215, 216 are proposed to facilitate interaction between non-adjacent qubit islands (207, 209) or (208, 210) to leverage spin-photon entanglement. The spin-photon entanglement may be controlled via the microprocessor 229 via the classical links 225, 226, 227, 228.

In another embodiment, the classical links 225, 226, 227, 228 expand above the multiple qubit islands 207, 208, 209, and 210 in the area as shown by dotted boxes 230, 231, 232, 233. The expansion of the classical links may allow a more efficient spin photon coupling in each of the qubit islands. Further, the microprocessor 229 may control optical links between the outside of the system 200 as shown by the classical links 0205, 206, 211, 212 extending outwards allowing for the formation of repeated structures. Further, the system 200 comprising an architecture 234 may act as a single unit, and the architecture 234 may be replicated to add more qubit structures. In another embodiment, depending on the requirement, the classical links 221, 222, 223, 224 and 217, 218, 219, 220 and optical links 213, 214, 215, 216 may be routed in multiple ways and in multiple directions while implementing the execution of certain simulations.

In an additional embodiment, a flat hierarchy with grid structure for qubit islands may be realized for multiple processors. The proposed flat hierarchy may create a network wherein each microprocessor connects with 4 qubit islands as shown in FIG. 2 along with four other microprocessors placed in adjacent grids. Hence, each qubit island is connected to four microprocessors and vice versa. The grid structure may only allow a single hierarchy level due to the added redundancy of microprocessors for each qubit island. In one example, every alternate microprocessor may be configured to perform either error correction or algorithm execution in the grid. Thereby forming two levels of hierarchy by mere appropriate configuration of the microprocessors. In one embodiment, the number of processors used at different hierarchical levels is optimized for minimal resource overhead, forming a fractal pattern as depicted by FIG. 3 and FIG. 4, with the architecture 234 in FIG. 2 may act as a fractal initiator.

FIG. 3 depicts an exemplary system 300 that illustrates a scaled up architecture of FIG. 2 with two hierarchy levels, in accordance with yet another embodiment. The system 300 represents two hierarchical levels in an architecture design. In one embodiment, four qubit islands 207, 208, 209, and 210 with a single microprocessor 229 used in FIG. 2 forms the lowest hierarchy structure in FIG. 3. The system 300 comprises of an architecture 0318 containing a plurality of unit cells 301, 302, 303, 304 controlled by a microprocessor 317 at a higher hierarchical level. As per one embodiment, the microprocessor 317 coordinates via interrupts to each of microprocessors placed in the unit cells 301, 302, 303, 304 via classical links 305, 306, 307, 308.

Further, the microprocessor 317 coordinates the coupling between the unit cells 301, 302, 303, 304 by controlling the coupling links 309, 310, 311, 312 via classical connections 313, 314, 315, 316. The microprocessor 317 may send interrupts to a microprocessors/controllers of any qubit islands of the lower hierarchy level for executing an operation on a particular qubit island or to read back the measurement results as collected at the lowest level. The qubit islands may also be responsible to coordinate the timing of the operations performed by various qubit islands.

FIG. 4 depicts an exemplary system 400 that illustrates a scaled up architecture of FIG. 2 with multiple hierarchy levels, in accordance with yet another embodiment. In one embodiment of FIG. 4, the architecture of FIG. 3 may be treated as a unit cell 0318, and the system 400 may be easily expanded to multiple hierarchy levels as shown in FIG. 4. In one embodiment of FIG. 4, multiple unit cells 401, 402, 403, 404 may be controlled via a central microprocessor 417. The central processor 417 is coupled to the multiple unit cells 401, 402, 403, 404 via classical control links 405, 406, 407, 408.

In another embodiment of FIG. 4, the central processor 417 may be responsible for mapping of software qubits to hardware qubits of the system 400 and maintaining synchronization of different microprocessors of qubit islands at the lower hierarchy levels. In yet another embodiment of FIG. 4, the central processor 417 may also control the coupling links 409, 410, 411, 412 via classical connections 413, 414, 415, 416 between the multiple unit cells 401, 402, 403, 404.

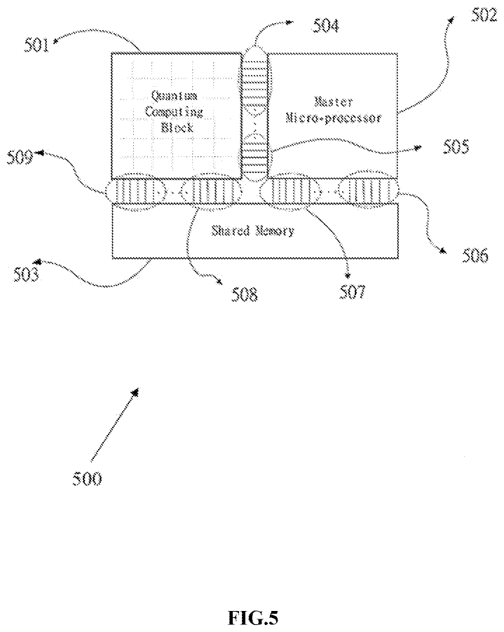

FIG. 5 depicts a block diagram of a hybrid quantum-classical architecture 500, in accordance with another embodiment. According to another embodiment of the invention, the hybrid quantum-classical architecture 500 may provide a provision to introduce a design for microprocessors at a second hierarchy level to control multiple unit cells at the first hierarchical level. In one embodiment, controlling the multiple unit cells at the first hierarchical level enables optimization of the number of microprocessors/controllers required for any required task assigned at a given point of time. In one embodiment, many combinations of the number of microprocessors/controllers used per qubit island can be made with a similar architectural concept.

In another embodiment, FIG. 5 also depicts a block diagram that integrates a memory 503 shared with a hierarchical quantum computing block 501. In one example, a hierarchical quantum computing block 501 may represent the hierarchical architecture outlined in FIG. 4, and a master microprocessor 502 that is responsible for running quantum algorithms and instructing the slave processors sitting inside the quantum computing block 501.

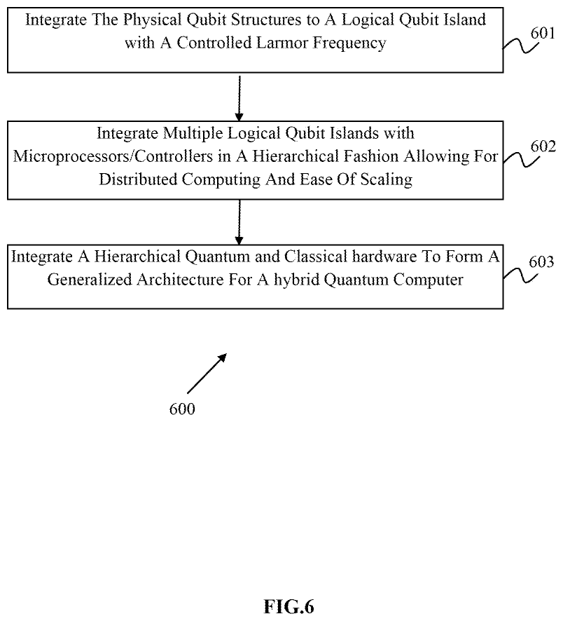

In another embodiment, the master microprocessor 502 is also responsible for compiling a received set of instructions to either direct them to the quantum computing block 501 or the classical master microprocessor 502 and scheduling out relevant commands to the quantum computing block 501 as necessary. The classical instructions are processed in the master microprocessor 502. In another embodiment, the quantum computing block 501 and the master microprocessor 502 may have access to the shared memory 503 via connections represented as (504, 505, 506. 507, 508, 509). The master microprocessor 502 is responsible for scheduling and optimizing tasks and communication to the outside world. A method co-integrating the qubit structures for defining the qubit operating frequencies is described along with FIG. 6.

FIG. 6 illustrates a flow diagram 600 depicting a method for controlling a qubit in a decentralized and distributed manner to obtain a scalable structure of a hybrid quantum-classical architecture, in accordance with an embodiment. At step 602, an integration of a physical qubit structure into a logical qubit island is carried out while establishing a controlled Larmor frequency. At step 604, an integration of a multiple logical qubit islands (from step 602) with one or more microprocessors/controllers is carried out in a hierarchical fashion, which enables a distributed computing and ease of scaling. At 606, an integration of a hierarchical quantum hardware (from step 604) and a classical hardware is carried out to form a generalized architecture for a hybrid quantum computer.

In an embodiment, integrating the physical qubit structure into a logical qubit island includes cleaning a typical silicon substrate, forming a typical gate oxide and depositing a gate layer, performing doping for source and drain region and forming contact to source, drain and gate in subsequent metallization process, etching is performed to remove excess metal, and depositing an oxide layer and then metallization and patterning to achieve the required metal loop structures for realizing current carrying loop in subsequent metal layers.

In an embodiment, the method further includes forming a required contact to the qubits and the metal loops in subsequent metal layers, wherein a number of qubits in an island is selectable by a user depending on a number of physical qubits needed for a single logical qubit.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

The embodiments of the present invention provide a method and a system for controlling a qubit in a decentralized and distributed manner to obtain a scalable structure of a hybrid quantum-classical architecture that provides an architectural modification to standard semiconductor qubits that facilitate their individual tunability and simultaneous control, while also paving the way for the integration of millions of more qubits due to its ability to multiplex hardware and lower overall power consumption.

Further, the system enables control and regulation of all qubit-related tasks down to an optimal level of abstraction. The architecture effectively controls qubit resonance frequencies while also distributing computational tasks across various layers of abstraction. Also, the architecture has added provision for electro-optical modulator switches which can perform two-qubit operations between separated logical qubits via spin-photon coupling. Further, the architecture allows reusability of a same set of Larmor frequencies over multiple Logical qubit islands, thus significantly reducing the control and readout hardware overheads. Furthermore, the system enables a correct operation sequence maintenance to execute an algorithm and synchronize the execution processes at lower and higher levels of hierarchy of qubits arrangement based on the interrupts received from microprocessors or controllers.

The various embodiments of the present system include micro-structures that can be made grid-like structure, allowing for flexible control of local magnetic fields or generation of a local magnetic field gradient for the qubits, thus forming a vector magnet. The microstructures can be superconducting or normal metal structures based on the requirements of the local magnetic field strength and the operational temperature for the qubits. Lower temperatures facilitate superconducting micro-structures with higher magnetic field densities.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

The scope of the embodiments will be ascertained by the claims to be submitted at the time of filing a complete specification.

What is claimed is:

1. A system for controlling a qubit in a decentralized and distributed manner for obtaining a scalable structure of a hybrid quantum-classical architecture, the system comprising:
a circuit configured to provide an operation frequency control of qubits in an island representation of a logical qubit island with a plurality of physical qubits along with independent magnetic-field control to each qubit on a hardware substrate, the circuit comprising:
a plurality of micro/nano-scale current-carrying structures in the vicinity of a qubit for controlling and manipulating the qubit using the locally generated variable magnetic field, in turn controlled by a tunable current flowing through the plurality of micro/nano-scale current-carrying structures;
wherein the plurality of micro/nano-scale current-carrying structures in conjunction with a fast current control are configured to provide fast switching/tuning of magnetic fields enabling rapid adiabatic passage control of one or more qubits simultaneously.

2. The system of claim 1, wherein multiple physical qubits are combined to form a logical qubit.

3. The system of claim 2, wherein the logical qubit comprises an island of qubits and wherein the logical qubit is provided with an operating resonance frequency or Larmor frequency, controlled by the plurality of micro/nano-scale current-carrying structures.

4. The system of claim 2, wherein the multiple logical qubits or islands of qubits are interconnected via optical links leveraging spin-photon entanglement, wherein the optical links are referred to as photonic links.

5. The system of claim 3, wherein the photonic links are capable of connecting multiple logical qubits with high data rates.

6. The system of claim 3, wherein the photonic links are made of high-K material or photonic crystals, wherein the photonic links are controlled by electro-optical modulators.

7. The system of claim 1, further comprising:
one or more microprocessors placed in a hierarchical fashion, and responsible for one or more of:
controlling qubit couplings, quantum error correction, algorithm execution, compilation, and synchronization, depending on a level of hierarchy.

8. The system of claim 7, wherein the lowest level microprocessors or controllers are responsible for one or more of controlling the coupling between any two adjacent logical qubits, defining the resonance frequencies of the logical qubits by modulating the current in the corresponding current-carrying structures, reading and controlling the logical qubits, and running quantum error-correction cycles on the adjacent logical qubits.

9. The system of claim 8, further comprising one or more microprocessors at higher levels in the hierarchy are responsible for one or more of controlling the coupling between two-level structures, passing the required control sequences for qubit operation to the microprocessor or controller at the lower hierarchy level, and maintaining the timing accuracy of the operations.

10. The system of claim 9, wherein the microprocessors or controllers at an even higher level of the hierarchy are responsible for the mapping of software qubits to hardware qubits in the most optimized manner.

11. The system of claim 1, wherein at the highest level of hierarchy, a master microprocessor is responsible for synchronization and compilation of various algorithms that are required to be executed on quantum bits.

12. The system of claim 1, wherein a memory structure is shared between the master microprocessor and the quantum computing block.

13. The system of claim 1, wherein the architecture is modular and scalable, wherein hierarchical repetition of multiple microprocessors or controllers tasks allows for optimal hardware design and dynamic control.

14. The system of claim 1, wherein the design of the architecture can be extended to a plurality of qubits by adding more qubit islands into the architecture design.

15. A method for controlling a qubit in a decentralized and distributed manner to obtain a scalable structure of a hybrid quantum-classical architecture, the method comprises:
integrating a physical qubit structure into a logical qubit island while establishing a controlled Larmor frequency;
integrating a plurality of logical qubit islands with one or more microprocessors/controllers in a hierarchical fashion, for enabling a distributed computing and ease of scaling; and
integrating a hierarchical quantum hardware and a classical hardware to form a generalized architecture for a hybrid quantum computer.

16. The method of claim 15, wherein integrating a physical qubit structure into a logical qubit island comprises:
cleaning a typical silicon substrate;
forming a typical gate oxide and depositing a gate layer;
performing doping for source and drain region and forming contact to source, drain and gate in subsequent metallization process;
etching is performed to remove excess metal; and
depositing an oxide layer and then metallization and patterning to achieve the required metal loop structures for realizing current carrying loop in subsequent metal layers.

17. The method of claim 16, further comprises:
forming a contact to the qubits and the metal loops in subsequent metal layers, wherein a number of gaits in an island is selectable by a user depending on a number of physical qubits needed for a single logical qubit.
